(19) United States
(12) Patent Application Publication
(10) Pub. No.: US 2019/0118634 A1
(43) Pub. Date: Apr. 25, 2019

(54) VEHICLE

(71) Applicant: TOYOTA JIDOSHA KABUSHIKI KAISHA, Toyota-shi (JP)

(72) Inventor: Daisuke ITO, Kasugai-shi (JP)

(73) Assignee: TOYOTA JIDOSHA KABUSHIKI KAISHA, Toyota-shi (JP)

(21) Appl. No.: 16/110,391

(22) Filed: Aug. 23, 2018

(30) Foreign Application Priority Data
Oct. 25, 2017 (JP) 2017-206233

(51) Int. Cl. B60K 6/26; H02K 11/33; H02K 5/24

(52) U.S. Cl. CPC B60K 6/26; B60Y 2200/92; H02K 5/24; H02K 11/33

(57) ABSTRACT

A vehicle includes a drive motor, a power control device, a front bracket connected to a front face of a housing of the power control device, and a stopper provided on the front face of the housing of the power control device so as to be placed above the front bracket. A bottom face of the stopper is provided so as to face an upper end of the front bracket with a first gap being provided between the stopper and the upper end of the front bracket. The stopper is provided so as to abut with the upper end of the front bracket when the front bracket deforms so as to fall backward. The bottom face of the stopper is inclined upward toward the front side. The upper end of the front bracket is inclined upward toward the front side so as to face the bottom face of the stopper.

### INCORPORATION BY REFERENCE

The disclosure of Japanese Patent Application No. 2017-206233 filed on Oct. 25, 2017 including the specification, drawings and abstract is incorporated herein by reference in its entirety.

### BACKGROUND

### 1. Technical Field

The technique disclosed in the disclosure relates to an vehicle includes driving electric power controlled by a power control device.

### 2. Description of Related Art

Japanese Unexamined Patent Application Publication No. 2017-081366 (JP 2017-081366 A) describes an in-vehicle structure of a power control device for controlling driving electric power of a drive motor. In the in-vehicle structure, the power control device is provided in a front compartment of a vehicle. The power control device is supported by a front bracket and a rear bracket so as to be placed above a top face of a housing with a gap between the power control device and the housing. In the housing, the drive motor is accommodated. The reason why the gap is secured is to reduce vibration transmitted from the housing to the power control device.

When a vehicle collides with an obstacle, the front bracket falls backward due to impact received from the front side, so that the power control device might strongly interfere with the top face of the housing. In the in-vehicle structure in JP 2017-081366 A, a projection (a stopper) is provided on a front face of an electronic device so as to be placed above the front bracket. The stopper is provided such that, at the time when the front bracket falls backward, the stopper makes contact with an upper end of the front bracket before a bottom face of the power control device interferes with the top face of the housing. In the in-vehicle structure in JP 2017-081366 A, at the time of a front collision, the stopper abuts with the front bracket before the bottom face of the power control device interferes with the top face of the housing, so as to relieve impact of interference between the power control device and the top face of the housing.

### SUMMARY

When the front bracket interferes with the stopper at the time of a collision of the vehicle, a strong impact is applied to them, so that they receive damage. If the damage is large, the upper end of the front bracket or the stopper might break. When the front bracket or the stopper breaks, an impact relieving effect at the time when the power control device collides with the housing decreases. The disclosure makes it difficult for a front bracket and a stopper to break at the time when an upper end of the front bracket interferes with the stopper.

An aspect of the disclosure relates to an vehicle. The vehicle includes a drive motor, a power control device, a front bracket, and a stopper. The power control device is configured to control driving electric power to the drive motor. The front bracket is connected to a front face of a housing of the power control device. The stopper is provided on the front face of the housing of the power control device so as to be placed above the front bracket in a vehicle-highest direction. A bottom face of the stopper is provided so as to face an upper end of the front bracket with a first gap being provided between the stopper and the upper end of the front bracket. The power control device is supported by a housing of the drive motor via the front bracket so that the power control device is placed above the drive motor with a second gap. The bottom face of the stopper is provided so as to abut with the upper end of the front bracket when the front bracket deforms so as to fall backward of the vehicle. The bottom face of the stopper is inclined upward toward a front side. The upper end of the front bracket is inclined upward toward the front side so as to face the bottom face of the stopper.

In the configuration, when the front bracket is inclined so as to fall backward, the bottom face of the stopper makes surface contact with a top face of the front bracket. Since impact of a collision between the stopper and the front bracket is received by the surfaces, the impact caused due to interference therebetween is relieved, so that the stopper and the front bracket can hardly break.

The vehicle may further include a damping bush connected to the front face of the housing of the power control device. The front bracket may include a main plate portion configured to support the damping bush, vertical ribs provided on opposite sides of the main plate portion in a vehicle width direction, and an upper rib continuous with an upper end of the main plate portion and upper ends of the vertical ribs, the upper rib being inclined upward toward the front side. A top face of the upper rib may abut with the bottom face of the stopper when the front bracket deforms so as to fall backward of the vehicle. With the configuration, the vertical ribs and the upper rib raise strength of the front bracket and the upper rib receives, by its top face, the impact caused due to interference with the stopper, so that the impact is relieved.

In the vehicle, a front end of the upper rib may extend forward of the damping bush in the horizontal direction. With the configuration, the upper rib also functions as eaves for blocking a waterdrop to drop onto the damping bush.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view illustrating an exemplary component layout inside a front compartment;

FIG. 2 is a side view of a transaxle and a power control device;

FIG. 3 is an enlarged view of a range indicated by a reference sign III in FIG. 2;

FIG. 4 is a side view illustrating a positional relationship of the transaxle and the power control device after a bracket deforms;

FIG. 5 is an enlarged view of a range indicated by a reference sign V in FIG. 4;

FIG. 6 is a perspective view of the vicinity of a front face of the power control device to which a front bracket is attached;

FIG. 7 is a sectional view taken along a line VII-VII in FIG. 6; and

FIG. 8 is a sectional view taken along a line VII-VII in FIG. 6 (with an arrow indicative of a waterdrop).

### DETAILED DESCRIPTION OF EMBODIMENTS

Unless otherwise specified, a front face, an upper end, a top face, an bottom face, and a front end in the following description will respectively refer to the front face and the front end in the vehicle front-rear direction, and the upper end, top face and bottom face in the vehicle-highest direction. Further, “above” in the following description will respectively refer to “above” in the vehicle-highest direction and “backward” in the following description will respectively refer to “backward” in the vehicle front-rear direction.

An in-vehicle structure according to an embodiment will be described with reference to the drawings. An in-vehicle structure 2 of the embodiment is applied to a hybrid vehicle 100 including a motor 3 and an engine 98 for vehicle running. A power control device 20 is supported above a transaxle 30 in a front compartment 90. In the following description, the “transaxle 30” is referred to as “TA 30.”

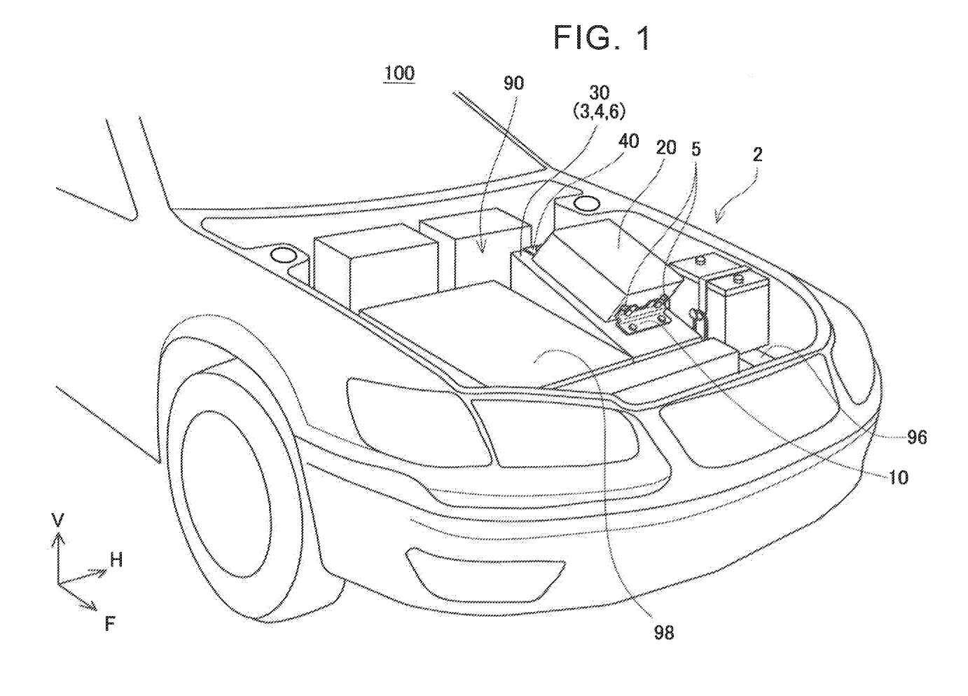

FIG. 1 illustrates a device arrangement in the front compartment 90 of the hybrid vehicle 100. Note that, in the coordinate system in the figure, the F-axis indicates the front side in the vehicle front-rear direction, the V-axis indicates the upper side in the vehicle up-down direction, and the H-axis indicates the left side in the vehicle width direction (the left of the vehicle). The meanings of the marks in the coordinate system are applied to the other figures.

The engine 98, the power control device 20, the TA 30, and so on are placed in the front compartment 90. Various devices are also placed in the front compartment 90, but those devices are not illustrated herein. It should be noted that the TA 30, the engine 98, and the like are illustrated schematically in FIG. 1.

The motor 3 is accommodated in a housing of the TA 30. In other words, the TA 30 corresponds to a housing in which the motor 3 is accommodated. The housing of the TA 30 is formed by die-casting or shaving of aluminum, for example. A box indicated by a reference sign 30 in FIG. 1 indicates the housing of the TA 30. In the following description, the “TA 30” shall also mean the housing of the TA 30. In the TA 30, a power distribution mechanism 6 configured to combine/distribute output torque of the engine 98 and output torque of the motor 3 is further accommodated. A differential gear 4 is also accommodated in the TA 30. The power distribution mechanism 6 divides the output torque of the engine 98 and transmits it to the differential gear 4 and the motor 3 according to a state. In this case, the hybrid vehicle 100 generates electric power by the motor 3 while the hybrid vehicle 100 runs by engine torque. The hybrid vehicle 100 also generates electric power by the motor 3 by use of deceleration energy of the vehicle at the time of braking. A high-voltage battery is charged with the electric power (regenerative power) obtained by the power generation.

The engine 98 and the TA 30 are connected such that they are adjacent to each other in the vehicle width direction. The engine 98 and the TA 30 are suspended by a side member 96 that secures structural strength of the vehicle. In FIG. 1, only one side member 96 is illustrated, but another side member also extends on the lower right side of the engine 98 in FIG. 1. The engine 98 and the TA 30 are suspended between two side members.

The power control device 20 controls driving electric power to the motor 3. More specifically, after the power control device 20 increases direct-current power of a high-voltage battery (not shown), the power control device 20 converts the direct-current power into alternating-current power suitable for driving of the motor 3 and supplies it to the motor 3. By controlling a voltage and a frequency of the alternating-current power appropriately, it is possible to adjust output torque of the motor 3. The power control device 20 also has a function to convert alternating-current regenerative power generated by the motor 3 into direct-current power and to further decrease a voltage thereof. The high-voltage battery is charged with electric power with the voltage thus decreased. Although details thereof are described later, the power control device 20 is supported with a gap between the power control device 20 and a top face of the TA 30.

The front side of the power control device 20 is supported by a front bracket 10, and the rear side thereof is supported by a rear bracket 40. A stopper 5 is provided on the power control device 20 so as to be placed above the front bracket 10. The stopper 5 will be described later more specifically.

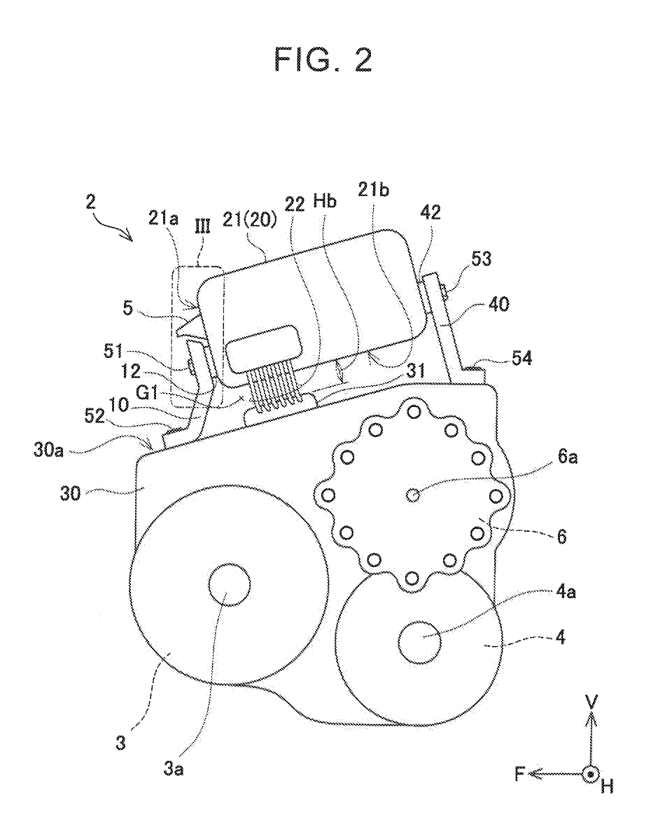

The relationship between the TA 30 and the power control device 20 will be described more specifically with reference to FIGS. 1 and 2. FIG. 2 is a general view of the in-vehicle structure 2. FIG. 2 illustrates a side view of the TA 30 and the power control device 20. A “side face” corresponds to a view when it is viewed from the vehicle width direction (the H-axis direction in the figure).

The power control device 20 is connected to the TA 30 via six power cables 22. The power cable 22 is a wiring harness via which electric power is sent from the power control device 20 to the motor 3. Although not described herein, two three-phase alternating current motors are accommodated in the TA 30, and two three-phase alternating currents are sent via the six power cables 22. A reference sign 31 indicates a cable connection portion provided in the TA 30.

As has been described earlier, the motor 3, the power distribution mechanism 6, and the differential gear 4 are accommodated in the TA 30. Inside the TA 30, an output shaft 3a of the motor 3, a main shaft 6a of the power distribution mechanism 6, and a main shaft 4a of the differential gear 4 are arranged in parallel to each other. Those three shafts extend in the vehicle width direction. As illustrated in FIG. 2, the three shafts are placed so as to form a triangle when they are viewed in the vehicle width direction. In order to place the three shafts, a top face 30a of the TA 30 is inclined downward toward the front side. Accordingly, the power control device 20 supported above the top face 30a is also placed so as to be inclined downward toward the front side. That the “power control device 20 is inclined downward toward the front side” means that the road clearance of a front end of the power control device 20 is lower than the road clearance of a rear end thereof.

The power control device 20 is supported by the front bracket 10 and the rear bracket 40 so as to be placed above the TA 30. The front bracket 10 is placed forward of the power control device 20, and the rear bracket 40 is placed behind the power control device 20. A gap G1 is secured between the power control device 20 and the TA 30. The gap G1 is secured by the front bracket 10 and the rear bracket 40.

A damping bush 12 is sandwiched between the power control device 20 and the front bracket 10, and a damping bush 42 is sandwiched between the power control device 20 and the rear bracket 40. The motor 3, the power distribution mechanism 6, and the differential gear 4 strongly vibrate during vehicle running. The damping bushes 12, 42 are attached so as to protect the power control device 20 from vibrations of the motor 3 and so on. Further, the reason why the power control device 20 is supported by the front bracket 10 and the rear bracket 40 so as to be placed above the TA 30 via the gap G1 is also to isolate the power control device 20 from vibrations of the motor 3 and so on.

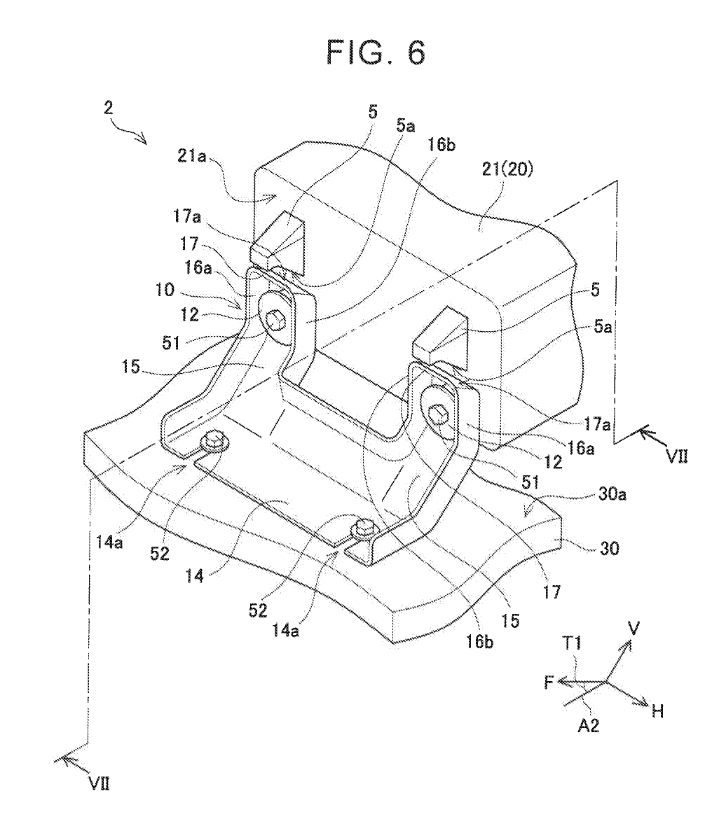

A lower part of the front bracket 10 is fixed to the top face 30a of the TA 30 by a bolt 52, and an upper part of the front bracket 10 is connected to a front face 21a of a housing 21 of the power control device 20 by a bolt 51. The damping bush 12 is sandwiched between the upper part of the front bracket 10 and the front face 21a of the housing 21. Although not illustrated in FIG. 2, the front bracket 10 is fixed to the TA 30 by two bolts 52 provided side by side in the vehicle width direction. Further, the front bracket 10 is fixed to the housing 21 of the power control device 20 by two bolts 51 provided side by side in the vehicle width direction. That the two bolts 52 are provided side by side in the vehicle width direction and the two bolts 51 are provided side by side in the vehicle width direction will be described later with reference to FIG. 6. The front bracket 10 is formed by press working of a metal plate (a steel plate). Note that, in FIG. 2, a shape of the front bracket 10 is simplified. A detailed shape of the front bracket 10 will be described later with reference to FIG. 6.

Although detailed descriptions are omitted, the rear bracket 40 also has the same structure as the front bracket 10. A lower part of the rear bracket 40 is fixed to the top face 30a of the TA 30 by a bolt 54, and an upper part of the rear bracket 40 is fixed to a rear face of the housing 21 of the power control device 20 by a bolt 53. The damping bush 42 is sandwiched between the upper part of the rear bracket 40 and the rear face of the housing 21.

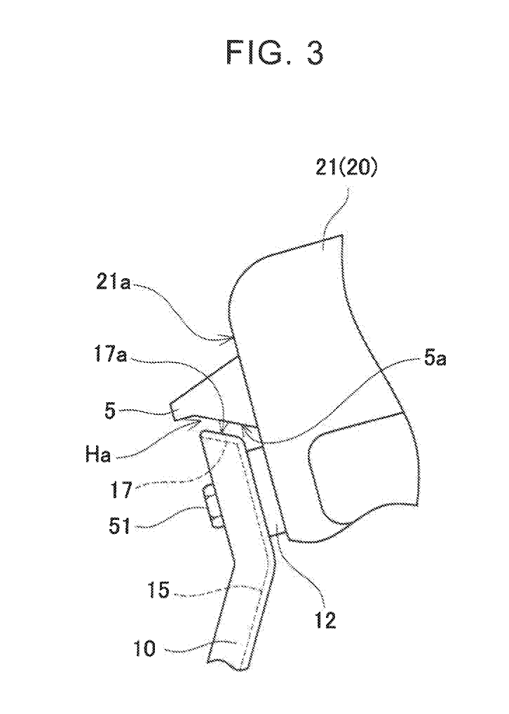

The stopper 5 is provided on the front face 21a of the housing 21 of the power control device 20. The stopper 5 is provided above the front bracket 10. FIG. 3 is an enlarged view of a range indicated by a reference sign III in FIG. 2. The stopper 5 is a projection projecting from the front face 21a of the housing 21. A bottom face 5a of the stopper 5 is inclined upward toward the front side. “To be inclined upward toward the front side” means that the road clearance of the bottom face of the stopper 5 gradually becomes higher toward the front side in the vehicle front-rear direction. The stopper 5 is placed so that the bottom face 5a faces a top face of the front bracket 10. Although details thereof are described later, the front bracket 10 is made of a single metal plate, and an upper rib 17 is placed on an upper end of the front bracket 10 such that a top face 17a of the upper rib 17 faces the bottom face 5a of the stopper 5. The top face 17a of the upper rib 17 is inclined upward toward the front side so as to face the bottom face 5a of the stopper 5. Although details thereof are described later, a plate of the front bracket 10, supporting the damping bush 12, is referred to as a main plate portion 15. The upper rib 17 is continuous with an upper end of the main plate portion 15. The top face 17a of the upper rib 17 corresponds to the top face of the front bracket 10.

The stopper 5 is placed such that a distance Ha (see FIG. 3) between the bottom face 5a of the stopper 5 and the top face of the front bracket 10 (the top face 17a of the upper rib 17) is shorter than a distance Hb (see FIG. 2) between a bottom face 21b of the housing 21 of the power control device 20 and the top face 30a of the TA 30. The cable connection portion 31 to which the power cables 22 are connected projects from the top face 30a of the TA 30, and a minimum distance Hb between the bottom face 21b of the housing 21 and the top face 30a of the TA 30 is a distance between a top face of the cable connection portion 31 and the bottom face 21b of the housing 21 of the power control device 20.

The distance Ha indicates a distance between the front bracket 10 and the stopper 5 before the front bracket 10 deforms due to a collision of the vehicle. The stopper 5 is provided so as to relieve impact caused when the power control device 20 hits the TA 30 at the time of a front collision (or a front oblique collision) of the vehicle.

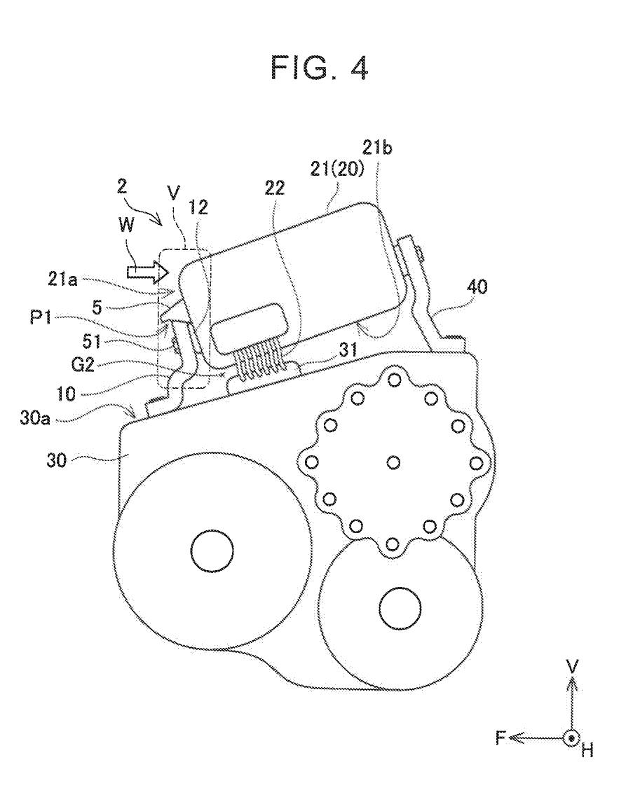

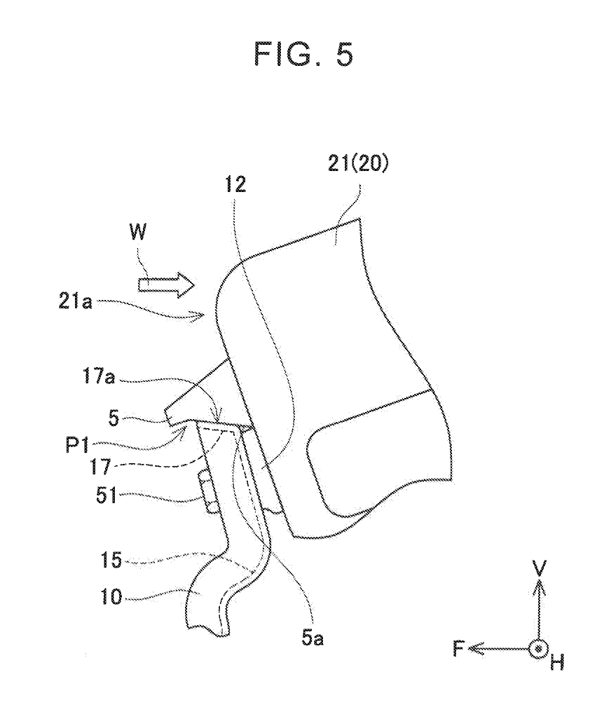

A function of the stopper 5 will be described with reference to FIGS. 4 and 5. In FIG. 4, an arrow indicated by a reference sign W indicates a collision load. The collision load W is a load caused when the vehicle has a front collision and is applied to the front end of the power control device 20. FIG. 4 illustrates deformations of the front bracket 10 and the rear bracket 40 at the time when the power control device 20 receives the collision load W. FIG. 5 is an enlarged view of a range indicated by a reference sign V in FIG. 4. The front bracket 10 is connected to the power control device 20 by the bolt 51, and the damping bush 12 is sandwiched between the front bracket 10 and the power control device 20. The damping bush 12 is made of an elastic body configured to absorb vibration and easily deforms. When the power control device 20 receives the collision load W from the front side, the front bracket 10 deforms so as to fall backward, and the bolt 51 fixing the front bracket 10 and the damping bush 12 deform so that the front bracket 10 approaches the stopper 5. As has been described earlier, the distance Ha (see FIG. 3) between the stopper 5 and the upper end of the front bracket 10 is shorter than the distance Hb (see FIG. 2) between the bottom face 21b of the housing 21 of the power control device 20 and the top face 30a of the TA 30. The stopper 5 is provided at a position where the stopper 5 abuts with the upper end of the front bracket 10 before the bottom face 21b of the housing 21 makes contact with the top face 30a of the TA 30, at the time when the front bracket 10 deforms due to a collision so as to fall backward.

When the front bracket 10 falls backward due to the collision load W, the stopper 5 abuts with the front bracket 10 before the bottom face 21b of the housing 21 makes contact with the top face 30a of the TA 30. When the deformation of the front bracket 10 stops, it is possible to prevent the housing 21 from colliding with the TA 30. When the collision load W is large and the front bracket 10 further deforms after the stopper 5 makes contact with the front bracket 10, the bottom face 21b of the housing 21 makes contact with the top face 30a of the TA 30. Even in that case, interference between the stopper 5 and the front bracket 10 relieves the impact of the collision between the bottom face 21b of the housing 21 and the top face 30a of the TA 30. A point P1 in FIGS. 4 and 5 is an abutment part between the stopper 5 and the upper end of the front bracket 10. As illustrated in FIG. 4, when the stopper 5 makes contact with the front bracket 10, a gap G2 is still secured between the bottom face 21b of the housing 21 of the power control device 20 and the top face 30a of the TA 30.

As illustrated in FIG. 5, when the front bracket 10 deforms, the top face of the front bracket 10 (the top face 17a of the upper rib 17) makes surface contact with the bottom face 5a of the stopper 5. Due to the surface contact, a contact load between the front bracket 10 and the stopper 5 widely disperses, so that the impact received by the front bracket 10 and the stopper 5 is relieved.

The shape of the front bracket 10 will be described. FIG. 6 illustrates a perspective view of the vicinity of the front face of the power control device 20 to which the front bracket 10 is attached. Note that, in the FHV coordinate system in FIG. 6, a straight line A2 parallel to the top face 30a of the TA 30 is added, and an angle TI formed between the F-axis extending horizontally in the vehicle front-rear direction and the straight line A2 indicates an inclination angle of the top face 30a to the horizontal direction.

The front bracket 10 is formed by press working of a single metal plate. The front bracket 10 is one continuous metal plate, but for purposes of this description, the front bracket 10 is divided into several parts. The front bracket 10 is mainly constituted by a base portion 14 fixed to the top face 30a of the TA 30, and a pair of main plate portions 15 rising from the base portion 14 and configured such that their upper parts face the front face 21a of the housing 21 of the power control device 20. Notches 14a are provided at two places in the base portion 14, and the bolts 52 fix the base portion 14 to the TA 30 via the notches 14a.

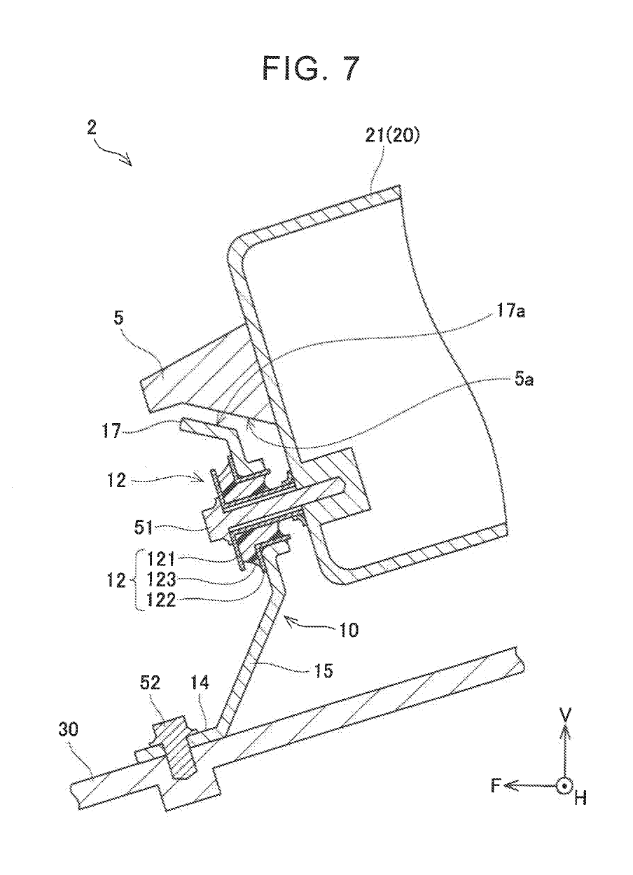

FIG. 7 is a sectional view taken along a line VII-VII in FIG. 6. The line VII-VII in FIG. 6 indicates a sectional view cut along a plane crossing the stopper 5 and the damping bush 12. The following describes the shape of the front bracket 10 with reference to FIGS. 6 and 7. For simplification of the description, in the following description, the bottom face 5a of the stopper 5 is referred to as a stopper bottom face 5a, and the top face 17a of the upper rib 17 is referred to as an upper rib top face 17a.

The main plate portion 15 facing the front face 21a of the housing 21 supports the damping bush 12. The damping bush 12 is placed so as to penetrate through the main plate portion 15, and the bolt 51 passes through the damping bush 12 so as to connect the front bracket 10 to the front face 21a of the housing 21 of the power control device 20. Note that the main plate portion 15 is provided with a through-hole, and the damping bush 12 is pressed into the through-hole.

Vertical ribs 16a, 16b are provided on the opposite sides of an upper part (a part facing the housing 21) of each of the main plate portions 15 in the vehicle width direction. The vertical ribs 16a, 16b are provided so as to rise forward in the vehicle front-rear direction from opposite edges of the main plate portion 15 in the vehicle width direction. A reference sign 16a indicates a vertical rib positioned on the outer side of each of the main plate portions 15 when it is viewed from the front side in the vehicle front-rear direction, and a reference sign 16b indicates a vertical rib positioned on the inner side of each of the main plate portions 15. The vertical ribs 16a, 16b are positioned on the opposite sides of the damping bush 12 so as to raise strength of the main plate portion 15 supporting the damping bush 12.

The upper rib 17 is provided so as to be continuous with an upper end of the main plate portion 15 and respective upper ends of the vertical ribs 16a, 16b. The upper rib 17 is bent (curved), in a direction distanced from the housing 21, from the upper end of the main plate portion 15 extending upward in parallel to the front face 21a of the housing 21. Opposite ends of the upper rib 17 in the vehicle width direction are continuous with the vertical ribs 16a, 16b. The upper rib 17 is bent (curved) from the upper end of the main plate portion 15 and extends upward toward the front side in the vehicle front-rear direction. In other words, the upper rib top face 17a is inclined upward toward the front side.

The stopper 5 is provided on the front face 21a of the housing 21 of the power control device 20 so as to be positioned above the upper rib 17 of the front bracket 10. As has been described earlier, the stopper bottom face 5a is inclined upward toward the front side generally in parallel to the upper rib top face 17a so as to face the upper rib top face 17a. The stopper 5 is placed such that the stopper bottom face 5a abuts with the upper rib top face 17a when the front bracket 10 deforms to be inclined backward. Since the stopper bottom face 5a is generally in parallel to the upper rib top face 17a, the stopper bottom face 5a and the upper rib top face 17a make surface contact with each other. Since the stopper bottom face 5a and the upper rib top face 17a make surface contact with each other, the impact applied to the stopper 5 and the upper rib 17 (the front bracket 10) is relieved as described earlier.

With reference to the sectional view of FIG. 7, the following describes the structure of the damping bush 12. The damping bush 12 is constituted by an inner cylinder 121, an outer cylinder 122, and a rubber bush 123. The outer cylinder 122 and the inner cylinder 121 each have a tubular shape and include a flange in one end of the tubular shape. The inner cylinder 121 is placed inward of the outer cylinder 122. The outer cylinder 122 and the inner cylinder 121 are placed coaxially such that their flanges face the front side in the vehicle front-rear direction. The rubber bush 123 is sandwiched between the outer cylinder 122 and the inner cylinder 121. The outer cylinder 122 is pressed into the through-hole of the main plate portion 15 of the front bracket 10. The bolt 51 penetrates through the inside of the inner cylinder 121. While a distal end of the inner cylinder 121 abuts with the front face 21a of the housing 21, the bolt 51 fixes the inner cylinder 121 to the housing 21. As well illustrated in FIG. 7, the inner cylinder 121 and the outer cylinder 122 are connected to each other via the rubber bush 123, and they do not make direct contact with each other. The damping bush 12 decreases vibration of the front bracket 10 (vibration of the TA 30), so that a vibration force transmitted to the housing 21 is decreased.

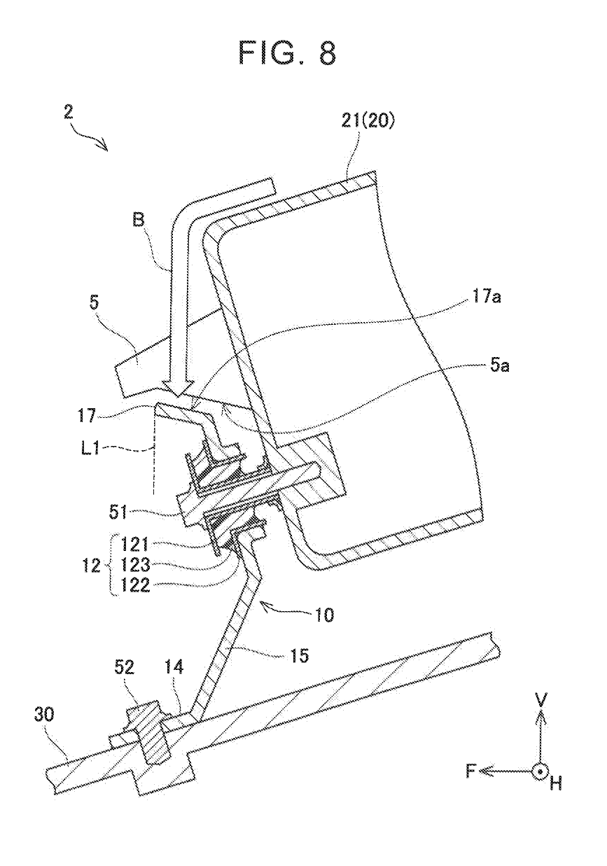

FIG. 8 illustrates a view in which an additional line is added to FIG. 7. A broken line L1 of FIG. 8 indicates a vertical line passing through the front end of the upper rib 17 of the front bracket 10. The front end (the broken line L1) of the upper rib 17 extends forward, in the vehicle front-rear direction, of a front end of the damping bush 12. A blank arrow B in the figure schematically indicates a waterdrop to drop forward of the housing 21 along the top face of the housing 21 of the power control device 20. As illustrated in FIG. 8, the upper rib 17 also serves as a role of eaves that prevent a waterdrop from dropping onto the damping bush 12. As illustrated in FIGS. 6 to 8, a part, of the damping bush 12, projecting forward from the main plate portion 15 is surrounded by the vertical ribs 16a, 16b and the upper rib 17, so that a waterdrop dropping from the upper side and a waterdrop splashing from its surroundings can be hardly attached thereto.

Below are notes regarding the technique described in the embodiment. As described above, the in-vehicle structure 2 of the present embodiment is configured such that the bottom face 5a of the stopper 5 provided on the front face 21a of the housing 21 of the power control device 20 makes surface contact with the top face (the upper rib top face 17a) of the front bracket 10 at the time when they interfere with each other, so that a load to be received by them is dispersed. As a result, the stopper 5 and the front bracket 10 both can hardly break at the time of the interference. The upper rib top face 17a corresponds to the top face of the front bracket 10.

The specific example of the disclosure has been described in detail. However, the example is for illustration only, and does not limit the scope of the claims. The technique described in the scope of the claims includes the foregoing example with various modifications and changes. Each of and various combinations of the technical elements explained in this specification and the drawings achieve technical utility, and the technical elements are not limited to the combination stated in the claims at the time of filing. The technique described in this specification and the drawings as an example is able to achieve a plurality of objectives simultaneously and has technical utility by achieving one of the objectives.

What is claimed is:

1. A vehicle comprising:
a drive motor;
a power control device configured to control driving electric power to the drive motor;
a front bracket connected to a front face of a housing of the power control device; and
a stopper provided on the front face of the housing of the power control device so as to be placed above the front bracket in a vehicle-highest direction, a bottom face of the stopper being provided so as to face an upper end of the front bracket with a first gap being provided between the stopper and the upper end of the front bracket, wherein:
the power control device is supported by a housing of the drive motor via the front bracket such that the power control device is placed above the drive motor with a second gap;
the bottom face of the stopper is provided so as to abut with the upper end of the front bracket when the front bracket deforms so as to fall backward of the vehicle;
the bottom face of the stopper is inclined upward toward a front side; and
the upper end of the front bracket is inclined upward toward the front side so as to face the bottom face of the stopper.

2. The vehicle according to claim 1, further comprising:
a damping bush connected to the front face of the housing of the power control device, wherein:
the front bracket includes
a main plate portion configured to support the damping bush,
vertical ribs provided on opposite sides of the main plate portion in a vehicle width direction, and
an upper rib continuous with an upper end of the main plate portion and upper ends of the vertical ribs, the upper rib being inclined upward toward the front side; and
a top face of the upper rib abuts with the bottom face of the stopper when the front bracket deforms so as to fall backward of the vehicle.

3. The vehicle according to claim 2, wherein
a front end of the upper rib extends forward of the damping bush in a horizontal direction.
